(19) United States
(12) Patent Application Publication
(10) Pub. No.: US 2002/0131386 A1
(43) Pub. Date: Sep. 19, 2002

(54) Mobility prediction in wireless, mobile access digital networks

(75) Inventor: Youngjune L. Gwon, Mountain View, CA (US)

Correspondence Address: Brinks Hofer Gilson & Lione, P.O. Box 10395, Chicago, IL, 60610, US

(73) Assignee: DoCoMo Communications Laboratories USA, Inc.

(21) Appl. No.: 09/770,544

(22) Filed: Jan. 26, 2001

(51) Int. Cl. H04Q 7/24

(52) U.S. Cl. 370/338

(57) ABSTRACT

Disclosed are methods for predicting the mobility of mobile nodes in third generation and beyond wireless, mobile access Internet protocol-based data networks embodying IETF Mobile IP support, as well as in wireless LANs. Conventional Mobile IP mobility detection is replaced with deterministic, stochastic, and/or adaptive methods to predict the mobility of a mobile node in the network employing network logic layer (L3) packet latency characteristics. The method is useful for providing pre-notification that a communication hand-off condition is imminent to enable fast route pre-establishment and reduced packet latency, and for optimizing quality of service by facilitating selection of best base station transceiver in overlapping cell environments, among other applications.

### BACKGROUND OF THE INVENTION

1. Field of the Invention

The invention relates generally to the communication of digital data in digital data networks and more specifically to communication of digital data in third generation and beyond wireless, mobile-access, Internet protocol-based data networks and wireless LANs. Still more specifically, the invention relates to methods of predicting the mobility of mobile node devices in such networks.

2. Statement of Related Art

Digital data networks have become a ubiquitous part of business, commerce, and personal life throughout the United States and the world. The public Internet and private local and wide area networks (LANs and WANs) have become increasingly important backbones of data communication and transmission. Email, file access and sharing, and services access and sharing are but a few of the many data communication services and applications provided by such networks. Recently, next generation data communication applications such as Voice over IP (VoIP) and real-time interactive multi-media have also begun to emerge.

Until relatively recently, digital data networks generally comprised a plurality of “fixed” connections or nodes. In “fixed” node networks, the nodes or network connections are fixed in place and are not mobile in nature. That is not to say the electronic devices that connect to such networks may not themselves be portable. Common network access devices include general purpose desktop and laptop personal computers, servers of various types, and more specialized electronic devices, such as personal information managers or assistants (PIMs or PIAs), for example. However, in a fixed node network, such devices connect to the network at fixed locations and are not mobile while connected to and communicating data over the network.

Fixed node digital data networks employ well-known protocols to communicate and route data between the network nodes. The well-known 7-layer OSI network model and the 4-layer Department of Defense ARPANet model, which are the forerunners of the modern Internet, define typical multi-layer network protocols. For example, the OSI model specifies a familiar hierarchy of protocols including low level physical hardware specifications and connections (Level 1), data link establishment and format (Layer 2), network addressing and routing (Level 3) data transport rules (Level 4) and so on. The modern Internet protocols are basically a melding of the OSI and ArpaNet protocols.

The Internet and nearly all digital data networks connected to it today adhere to substantially the same addressing and routing protocols specified in the “network layer” or “layer 3.” According to these protocols, each node in the network has a unique address, called the Internet Protocol (IP) address. To communicate digital data over the network or between networks, a sending or source node subdivides the data to be transmitted into “packets.” The packets include the data to be transmitted, the IP addresses of the source node and the intended destination node, and other information specified by the protocol. A single communication of data may require multiple packets to be created and transmitted depending on the amount of data being communicated and other well known factors. The source node transmits each packet separately, and the packets are routed via intermediary nodes in the network from the source node to the destination node by a “routing” method specified by the protocol and well known to those skilled in the art. See Internet protocol version 6, specified as IETF RFC 2460, which is incorporated herein by reference. The packets do not necessarily travel to the destination node via the same route, nor do they necessarily arrive at the same time. This is accounted for by providing each packet with a sequence indicator as part of the packetizing process. The sequence indicators permit the destination node to reconstruct the packets in their original order even if they arrive in a different order and at different times, thus allowing the original data to be reconstructed from the packets.

This approach introduces certain time considerations into the data communications process. Such time considerations arise for a number of reasons, including delays in the arrival of packets (latency) and delays due to the reconstruction of packets (packet jitter). For example, packets may be delayed in arrival if a specified or selected transmission route is interrupted due to problems at an intermediary node. In such cases, rerouting may be undertaken, which results in delay, or further transmission may await resolution of the problems at the intermediary node, which may result in even further delay. At the destination node, a certain amount of overhead is involved in processing packets in order to reconstruct their original sequence. Such overhead may increase substantially when a particular data communication involves a large number of packets, for example, or when the destination node is experiencing heavy processor loads due to other factors. In addition, it is possible for packets to be lost en route and to never reach the intended recipient node.

Nevertheless, the current approach works relatively well in fixed node networks for data communication applications that are relatively insensitive to time considerations. For example, the current approach works relatively well for email transmissions and file transfers, in part because such data communications are not real-time interactive applications and therefore are not particularly sensitive to latency and packet jitter considerations. Even lost packets do not pose insurmountable problems in the current approach, since the current fixed node Internet protocols allow for retransmission of packets if necessary.

However, the recent emergence of real-time interactive data communication applications, such as VoIP and real-time interactive multimedia, have presented substantial challenges for the current fixed node Internet protocol approach. Unlike email and file transfers, such real-time interactive data communication applications are highly sensitive to timing considerations such as end-to-end packet latency and packet jitter.

VoIP, for example, provides real-time, interactive end-to-end voice communications over IP digital data networks using standard telephony signaling and control protocols. In VoIP, voice signals are converted to digital format, packetized, transmitted, and routed over the IP network from a source node to a destination node using the commonly used Internet protocols. At the destination, the packets are reassembled, and the voice signals reconstructed for play back. All of the signal processing, transmission, and routing occurs in real time. In VoIP, packet latency manifests itself as delay between the time one party to a conversation speaks and another party to the conversation hears what the speaker said. Delays that exceed a threshold and interfere with the ability to converse without substantial confusion are unacceptable. It has been demonstrated that one way packet latency in the range of 0 ms to about 300 ms results in excellent to good communication quality, whereas latency above about 300 ms results in poor to unacceptable quality.

Packets lost during transmission also adversely impact the quality of VoIP communications. It has been demonstrated that speech becomes unintelligible if voice packets comprising more than about 60 ms of digitized speech data are lost. Packets can be lost in transmission for any number of reasons, including routing problems and the like. Because VoIP is a real-time interactive data communications application the current Internet protocols that provide for retransmission are of little help in this instance.

Packet jitter also substantially affects the quality of VoIP communications. In VoIP, packet jitter may result in the inability to reassemble all packets within time limits necessary to meet minimum acceptable latency requirements. As a consequence, sound quality can suffer due to the absence of some packets in the reassembly process, i.e., loss of some voice data. It has been determined that to achieve acceptable voice quality voice packet inter-arrival times generally must be limited to within about 40-60 ms. Within this range, data buffering can be used to smooth out jitter problems without substantially affecting the overall quality of the voice communications.

VoIP is but one example of a growing number of real-time interactive multimedia data communications applications that are highly sensitive to intra-network processing, transmission and routing delays. Similar applications, for example involving real-time interactive video and/or audio are subject to similar considerations.

Additionally, the current Internet addressing and routing protocols and approaches for fixed node data networks are incapable of supporting the dynamically changing addressing and routing situations that arise in recently proposed wireless, mobile-access digital data networks. The International Telecommunication Union (ITU) of the Internet Society, the recognized authority for worldwide data network standards, has recently published its International Mobile Communications-2000 (IMT-2000) standards. These standards propose so-called third generation (3G) and beyond (i.e., 3.5G, 4G etc.) data networks that include extensive mobile access by wireless, mobile node devices including cellular phones, personal digital assistants (PDA's), handheld computers, and the like. (See http://www.itu.int). Unlike previous wireless, mobile access, cellular telephony networks, the proposed third generation and beyond networks are entirely IP based, i.e., all data is communicated in digital form via standard Internet addressing and routing protocols from end to end. However, unlike current fixed node networks, in the proposed third generation and beyond wireless, mobile access networks, wireless mobile nodes are free to move about within the network while remaining connected to the network and engaging in data communications with other fixed or mobile network nodes. Among other things, such networks must therefore provide facilities for dynamic rerouting of data packets between the communicating nodes. The current Internet addressing and routing protocols and schemes, which are based on fixed IP addresses and fixed node relationships, do not provide such facilities. Similarly, current fixed node Internet protocols are not sufficient for wireless LAN usage.

Standards have been proposed to deal with the mobile IP addressing and dynamic routing issues raised in third generation and beyond, wireless, mobile access IP networks and wireless LANs. For example, the Internet Engineering Task Force (IETF), an international community of network designers, operators, vendors, and researchers concerned with the evolution of the Internet architecture and the smooth operation of the Internet, have proposed several standards to deal with IP addressing and dynamic rerouting in such mobile access networks. (See http://www.ietf.org). These include proposed standards for IP Mobility Support such as IETF RFC 2002, also referred to as Mobile IP Version 4, and draft working document “draft-ietf-mobileip-ipv6-12”, entitled “Mobility Support in IPv6,” also referred to as Mobile IP Version 6.

The proposed Mobile IP standards address the deficiencies of the current Internet addressing and routing protocols and schemes to accommodate network access and data communication by wireless, mobile node devices. However, they do not necessarily address the transmission timing and delay considerations, i.e., end-to-end latency and packet jitter, which are critical to real-time, interactive data communications applications like VoIP. Indeed, packet latency and jitter are an even more significant concern in the proposed third generation mobile access networks than in fixed node IP networks. One critical delay factor is the additional processing and overhead time required to “hand-off” the mobile node's network connection from and one access node to another as the mobile node changes location within the network. The hand-off process includes, among other things, establishing communications with the new access node, registering and authenticating the mobile node, updating its location in the network, attending to various authentication and security issues and requirements, and dynamically establishing a new data route between the mobile node and its correspondent node, i.e., the node with which it is communicating. Additional packet delays resulting from these necessary processes can significantly degrade the quality of data communications, particularly real-time interactive data communications, or even cause disconnections.

In addition to the advances in mobile network access technology, advances in wireless data communications technologies, including Code Division Multiple Access (CDMA) and Wideband Code Division Multiple Access (W-CDMA) technologies, now provide the bandwidth and data traffic handling capabilities necessary to make VoIP and other real-time interactive data communications applications and services available to users of mobile handsets and other wireless devices in cellular communications networks. However, these advanced communications technologies do not address packet transmission latency and jitter problems, which occur at the network level, and which must be resolved for VoIP and other real-time interactive data communications applications and services to become practically realizable in the proposed third generation and beyond wireless, mobile access IP-based networks.

Additional issues facing wireless, mobile access digital data networks include quality of service issues. Poor signal quality, excessive error correction, and resulting packet delays are characteristic of the issues which need to be addressed. Such issues can arise, for example, when mobile nodes employ less than optimal data connections with the network.

Efforts have been made to address the issues of packet transmission delay in mobile access IP networks due to the mobility of network nodes. One current IETF proposal suggests to extend the proposed Mobile IP standards to optimize the routing of packets by establishing a direct route between a mobile and correspondent node and bypassing the “tunneling” of packets through the mobile node's home “agent” router. (See “draft-ietf-mobileip-optim-09.txt” entitled “Route Optimization in Mobile IP” at www.ietf.org/internet-drafts). This proposal is directed to the well-known asymmetrical latency problems that result from “triangular routing” of packets between mobile and correspondent nodes under the proposed Mobile IP standards. However, the proposal is at least somewhat deficient because it depends upon detection of the mobility of mobile nodes and only addresses steady state latency issues. That is, the direct route for data communications envisioned by the current proposal is only established after mobility detection results in communications between the mobile and correspondent node having been handed-off from one neighboring node to another. Thus, the proposal does not address the significant delays incurred during and immediately following the hand-off process itself, which are perhaps the most critical with respect to real-time interactive data communications like VoIP. Moreover, the proposal does nothing to address quality of service issues.

Another proposal made by Su and Gerla working at UCLA is to use predictive mobility analyses to determine the direction and location of mobile nodes relative to other mobile nodes in a completely mobile “ad hoc” routing data network. In this proposal, global position satellite (GPS) technology is employed to determine the velocity and direction of movement of various mobile nodes to predict the duration of time neighboring nodes can remain in communication before a hand-off must occur. This proposal does not present a suitable solution for the packet delay problems facing third generation and beyond wireless, mobile access networks for a number of reasons. One reason is that the cost is prohibitive. Another is that the mathematical calculations involved are so extensive and complex that implementation is not practically possible in modern mobile node devices, which have relatively limited processing and computational facilities. Additionally and significantly, this proposal also offers nothing to address quality of service issues.

What is needed is a way to reduce packet latency and jitter in third generation and beyond wireless, mobile access Internet protocol data networks resulting from mobile nodes changing network access points during data communications.

Also needed is a way to optimize the quality of communications service with mobile nodes when such nodes have available a plurality of possible network access points.

Also needed is a way to provide the foregoing features and others that is susceptible to practical implementation in mobile node devices having relatively limited processing and computational facilities.

Also needed is an approach that is applicable not only to currently proposed wireless, mobile access networks but also to wireless LANs and other wireless, mobile access, digital data networks.

### SUMMARY OF THE INVENTION

The present invention achieves the foregoing features and results, as well as others, by providing methods to predict the mobility of mobile nodes in third generation and beyond, wireless, mobile access digital data networks and wireless LANs.

In one aspect, the invention employs control packet latency data derived in the Internet protocol network layer (L3) to predict the mobility of mobile node devices in the network relative to one or more fixed neighboring nodes or access points.

In another aspect, the invention employs deterministic, stochastic, and/or adaptive approaches to predict mobile node mobility, which are readily implanted in mobile node devices having limited processing and computational facilities.

In still another aspect, the invention applies predictive analyses to network link layer (L2) variables such as signal to interference ratio (SIR), signal to noise ratio (SNR), or pilot signal strength, related to mobility, to predict mobility of a mobile node in the network.

Using the methods of the invention, advance determinations can be made when a mobile node will be required to hand-off its network access from one access node to another. This in turn permits the pre-establishment of new data routes between mobile and correspondent nodes, thereby reducing packet latency and jitter resulting from the hand-off process. The methods of the invention also enable significant improvements to be made in the quality of communications involving mobile nodes when multiple network access points are available for connection, by providing a basis for selecting the optimum access point. Many other applications in third generation and beyond wireless, mobile access digital data networks will also benefit from application of the invention.

### BRIEF DESCRIPTION OF SEVERAL VIEWS OF THE DRAWINGS

FIG. 1 is a graphical representation of a third generation wireless, mobile access, Internet protocol-based data network in which the present invention is intended to operate;

FIG. 2 is a simplified graphical representation of mobile node mobility and network access point hand-off in a third generation wireless, mobile access, Internet protocol-based data network with Mobile IP;

FIG. 3 is a functional diagram illustrating the operation of a preferred deterministic mobility prediction method in a wireless, third generation, mobile access Internet protocol-based data network;

FIG. 4 is a functional diagram illustrating the operation of a preferred stochastic mobility prediction method in a wireless, third generation, mobile access Internet protocol-based data network; and

FIG. 5 is a functional diagram illustrating the operation of a preferred adaptive mobility prediction method in a wireless, third generation, mobile access Internet protocol-based data network.

### DETAILED DESCRIPTION OF THE PREFERRED EMBODIMENTS

The presently preferred embodiments of the invention are described herein with reference to the drawings, wherein like components are identified with the same references. The descriptions of the preferred embodiments contained herein are intended to be exemplary in nature and are not intended to limit the scope of the invention.

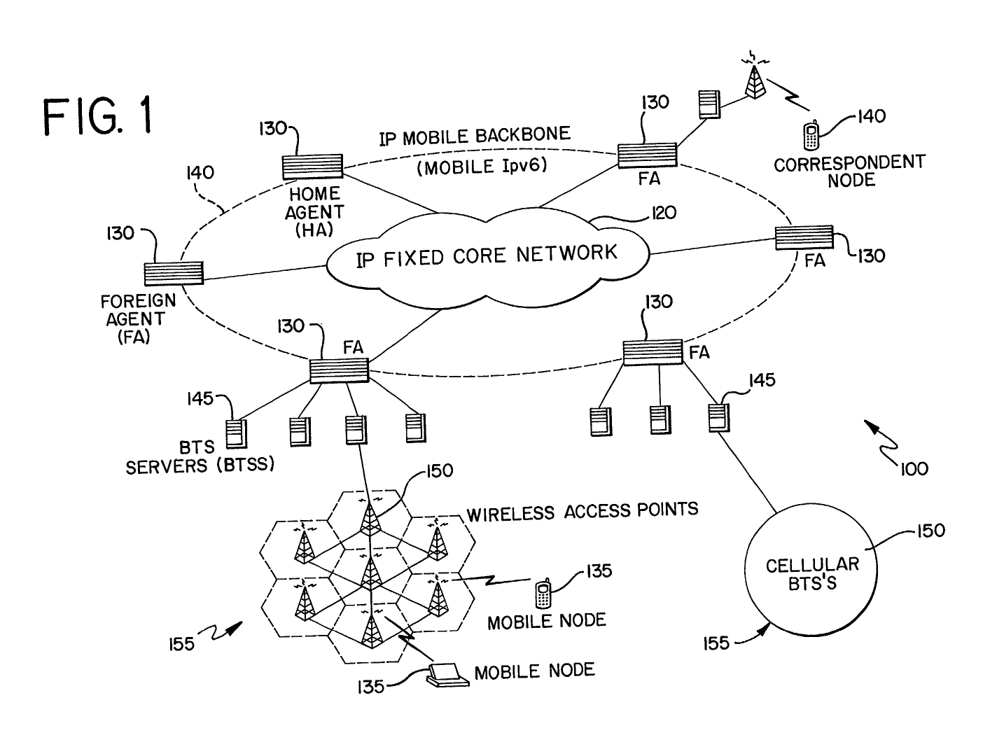

FIG. 1 illustrates graphically an exemplary third generation, wireless, mobile access, IP data network 100 in which the invention is intended to find application. For purposes of the present description, it is assumed the data network 100 adheres to the IMT-2000 standards and specifications of the ITU for wireless, mobile access networks. Additionally, it is assumed the data network 100 implements Mobile IP support according to the proposed Mobile IP version 4 or Mobile IP version 6 standard of the IETF. These standards and specifications, as published on the web sites of ITU and IETF, are incorporated herein by reference.

The wireless, mobile access, IP data network 100 has as its core a fixed node IP data network 120 comprising numerous fixed nodes (not shown), i.e., fixed points of connection or links. The core network 120 itself is conventional. Digital data is communicated within and over the network in accordance with well-known, conventional Internet protocols such as Internet protocol version 6, specified as IETF RFC 2460, which is incorporated herein by reference. Some of the nodes of the core network 120 comprise conventional routers (not shown), which function as intermediary nodes in accordance with conventional Internet addressing and routing protocols to route packets of data between source and destination nodes connected to the network.

Built on the core network 120 is a collection of servers/routers 130 which comprise an IP mobile backbone 140. The servers/routers 130 comprising the IP mobile backbone are themselves nodes of the core network 120 and are interconnected via the core network 120. The servers/routers 130 function as home agents (HA) and foreign agents (FA) to interface mobile nodes 135 and mobile correspondent nodes 140 to the core network 120, as specified in IETF RFC 2002 (“Mobile IP Version 4”), which is incorporated herein by reference. Mobile nodes may comprise any number of different kinds of mobile, wireless communication devices including cellular handsets, cellular telephones, hand-held computers, personal information managers, wireless data terminals, and the like.

Pursuant to RFC 2002, each mobile node 135, 140 is assigned a home network. Each mobile node 135, 140 also has a home agent, which comprises a router on the mobile node's home network. A mobile node's home agent is its point of connection to the network 120 when the mobile node is operating in its home network area. The mobile node's home agent also functions to route packets to and from the mobile node when it is operating in its home network area. According to the proposed Mobile IP support standards, the mobile node's home agent also maintains current location information for the mobile node when it is operating away from its home network area, and continues to participate in routing packets to the mobile node at its foreign location, at least in the proposed base Mobile IP version 4 standard.

Other routers comprising the Mobile IP backbone 140 function as foreign agents. Foreign agents provide network access points for the mobile node 135 when it is operating away from its home network area. The foreign agent via which a mobile node is connected to the network at a given time and location, also functions to route packets to and from the mobile node 135.

As in conventional fixed node Internet protocol-based data networks, each node in the network 120 has a unique IP address. Similarly, each agent/router comprising the Mobile IP backbone 140 has its own unique IP address, as does each mobile and correspondent node.

The mobile nodes 135, 140 communicate with the agents 130 by way of base transceiver station servers (BTSS's) 145 and base transceiver stations (BTS's) 150. An agent 130 may have network connections to multiple BTSS 145. Each BTSS 145 comprises a node in the network and has a unique IP address like any other network node. Each BTSS 145 serves a sub-network 155 of BTS's 150 and functions as an interface between the sub-network 155 and the data network 100. The mobile nodes 135, 140 and the BTS's employ known CDMA, W-CDMA or similar digital data communication technology to communicate with each other.

The construction, arrangement, and functionality of the BTSS's 145 and subnetworks 155 of BTS's is conventional and standard. Similarly, the implementation of CDMA, W-CDMA or similar digital data communication technology in wireless, mobile node devices 135 and BTS's, and the implementation of digital data communications between the two entities is standard. Detailed description thereof is not necessary to a complete understanding and appreciation of the present invention and is therefore omitted.

Within the overall data network 100, three levels of mobile node mobility are contemplated. Macro-mobility refers to a change in location of a mobile node such that it leaves its home area and agent and enters an area served by another agent. In other words, the mobile node's link or connection to the data network changes from one agent to another. Macro-mobility encompasses changes between a home and foreign agent or between foreign agents, and is also called inter-agent mobility. Intermediate mobility refers to a change in location of a mobile node wherein its link to the network changes from one BTSS to another. For example, a mobile node may change location such that it moves from one BTS sub-network 155 to another. Finally, micro-mobility refers to a change in location of a mobile node within a BTS subnetwork 155, in which case the mobile node's network link does not change.

The handling of intermediate mobility and micro-mobility are well known in wireless, cellular communication networks. For example, it is well known to use beacon signal strength for detecting and handling communication hand-offs between BTS's when a mobile node device 135 changes location on a micro-mobility scale. Similarly, the detection and handling of communication hand-off's between BTSS' when a mobile node 135 changes location across BTS sub-network boundaries is standard. In both cases, a detailed description is unnecessary to attain a complete understanding and appreciation of the present invention and is therefore omitted.

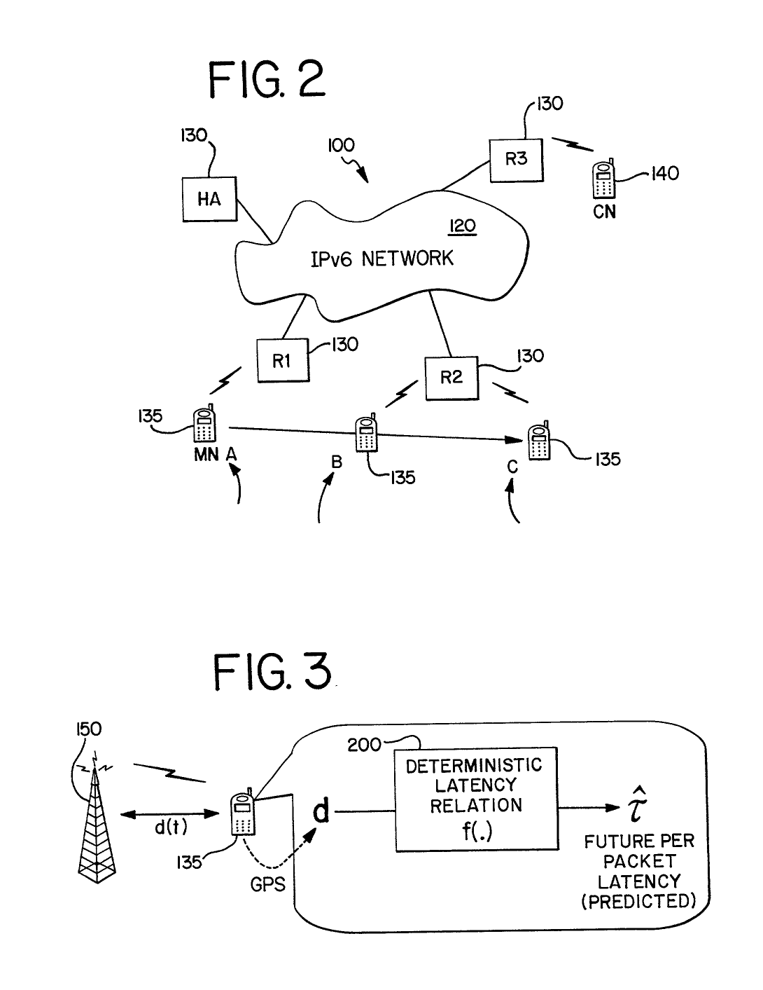

In the context of the present example, the invention is applied in connection with the macro-mobility level wherein a mobile node changes location within the network such that its network link changes from one agent to another. However, in other contexts, such as the wireless LAN context, the invention will find applicability at micro-mobility level. FIG. 2 provides a simplified graphical illustration of mobile node macro-mobility and the hand-off process in a third generation, wireless, mobile access data network embodying Mobile IP version 6 mobility support. In that example, the network connection hand-off operation between agents that results from mobile node macro-mobility is specified in IETF RFC 2002 for proposed Mobile IP version 4 and in “draft-ietf-mobileip-ipv6-12.txt” at “www.ietf.org/internet-drafts” for proposed Mobile IP version 6.

The process begins with a mobile node (MN) 135 at a starting location A within the network 100. At this location, the mobile node 135 is in data communication with a correspondent node (CN) 140, which in this example happens to be another mobile node device, but which also be a fixed node. While the mobile node 135 is at starting location A, data communication between mobile node 135 and correspondent node 140 is via the core network 120 and local routers R1 and R2, which provide network connections for the nodes 135, 140. The mobile node 135 and correspondent node 140 preferably communicate with their respective local routers R1 and R2 wirelessly using CDMA, W-CDMA or similar wireless broadband spread-spectrum signal technology, for example, via BTS's and BTSS's, which are not shown in this example. In the example illustrated, mobile node 135 is already operating away from its home area and home area router (HA) and is connected to the network via a local router R1. However, the situation would be similar if the mobile node's 135 starting location A was in its home area, it was connected to the network and communicating with the correspondent node 140 via its home area router (HA) 130, and it then moved from its home area to another location.

It is worth noting that because this example involves a network implementing Mobile IP version 6, the home area (HA) and local routers (R1 and R2) are not referred to as home and foreign agents as in Mobile IP version 4. The detailed reasons for this are given in the Mobile IP version 6 draft IETF document and IETF RFC 2002, both of which have been previously identified and incorporated herein by reference. Both versions provide similar mobility detection and hand-off functionality, however. In both versions, mobility of the mobile node 135 is detected via a Neighbor Discovery mechanism and results in a hand-off of the mobile node's network connection from a first router or agent to a second router or agent when the mobile node travels away from the area served by the first router or agent and enters the area served by the second router or agent. This functionality is the same whether the first router is the mobile node's home network router or a foreign router. Similarly the functionality is the same whether the first router is the mobile node's home agent or a foreign agent. In both versions, the hand-off processing is a significant source of packet latency, which affects the quality of real-time interactive data communications between mobile and correspondent nodes. Thus, while the example illustrated is described with respect to a Mobile IP version 6 network, similar functionality and considerations exist for Mobile IP version 4 networks.

As the mobile node (MN) 135 moves from starting location A to intermediary location B, its movement is detected by one or more of a number of known mechanisms. Typically, the movement is detected in the media access control (MAC) portion of the mobile node's network link layer (L2) programming. Specific implementations vary but one known method includes the use of Down/Testing/Up interface status, as set forth in IETF RFC 1573, which is incorporated herein by reference. Another employs the detection of beacon signal strength. Another involves evaluation of the quality of the signals received by the mobile node 135. A detailed description thereof is not necessary to a complete understanding and appreciation of the invention and is therefore omitted.

Alternatively or additionally, the mobile node (MN) 135 can employ the Neighbor Discovery methodology specified in IETF RFC 2461, which is incorporated herein by reference, and which is recommended for Mobile IP version 6 mobile nodes in the IETF Mobile IP Version 6 draft document (section 10.4) previously identified and incorporated by reference. In this methodology, the mobile node 135 uses so-called Neighbor Unreachability Detection (1) to detect TCP acknowledgements of data packets sent to its local router R1, and/or (2) to receive Neighbor Advertisement messages from its local router R1 in response to Neighbor Solicitation messages from other mobile node devices in the area, and/or (3) to receive unsolicited Router Advertisement messages from its local router R1. The receipt of TCP acknowledgements indicates the mobile node's network connection via the local router R1 is still viable. The receipt of Neighbor Advertisement and/or Router Advertisement messages indicates the presence of other local routers which could provide network connections for the mobile node.

At some point as mobile node 135 reaches intermediary location B and continues toward location C, its network connection via local router R1 begins to degrade. The degradation is typically detected as described in the preceding paragraphs based on a loss of signal strength or reduction in signal quality, and/or as the loss of TCP acknowledgements or the detected presence of other local routers. Conventionally, the internal programming of the mobile node device is such that once a preset threshold is reached, the mobile node 135 seeks to identify a new local router and to establish a new network connection via that router to replace its degraded network connection via local router R1.

The mobile node 135 may identify available local routers using the Neighbor Discovery methodology described in RFC 2461 and the IETF Mobile IP version 6 draft document (section 10.4). Thus, the mobile node 135 may broadcast Router Solicitation messages to determine if any local routers are available, or may wait to receive unsolicited multicast Router Advertisement messages from available routers. In the example illustrated, mobile node 135 could broadcast a Router Solicitation message. When local router R2 receives the message, it would respond directly to mobile node 135 with a Router Advertisement message. Alternatively, mobile node 135 could simply receive an unsolicited Router Advertisement message from new local router R2. In either event, the mobile node will have identified new local router R2 with which to establish its new network connection.

Once the new local router R2 is identified, the mobile node 135 hands-off its network connection from the prior router R1 to the new router R2 by registering with the new router R2 and de-registering with the prior router R1. As part of the registration/de-registration process, the mobile node or new router R2 provides binding updates, i.e., sends a new “care of” IP address, to the mobile node's home router and to the correspondent node with which the mobile node is communicating. This enables packets to be routed to and from the mobile node via the new router R2 instead of the prior router R1. Mobile node authentication and security processes are also performed to ensure the mobile node 135 is in fact legitimate and to avoid problems like eavesdropping, active replay attacks, and other types of attacks and unauthorized access to confidential data. Security and authentication measures are described in detail in the IETF Mobile IP version 6 draft document, which has been incorporated herein by reference. Others are described in IETF RFC 2401, 2402, and 2406, which are likewise incorporated herein by reference. The hand-off process and related authentication and security processes are described in detail in the proposed IETF Mobile IP standard documents previously identified and incorporated herein by reference, in IETF RFC 2462, which is also incorporated herein by reference, and in the other RFC's identified in this paragraph. Detailed description thereof is not necessary to attain a complete understanding and appreciation of the present invention and is therefore omitted. However, it will be apparent to persons skilled in the art that the hand-off process contemplated takes a substantial period of time to perform, results in increased packet latency and jitter due to the introduction of asymmetrical triangular routing among other things, and increases the probability of lost packets due to misrouting. Persons skilled in the art will also realize the proposed IETF Mobile IP support and related standards do not address the selection of a new network connection by the mobile node 135 when multiple connection nodes are present and available, and therefore do not address selecting the optimum connection.

The present invention addresses both the packet latency and optimum network connection issues, among others, by providing methods for predicting mobile node mobility. Preferably, the methods of the invention will replace the current mobility detection methods of the proposed Mobile IP standards. Using the methods of the invention, the mobile node 135 is able to determine in advance when a network connection hand-off is imminent. Using this information, the mobile node can pre-establish a new network connection with a new router or agent, and pre-establish a new packet route with a correspondent node with which it is communicating, while retaining its previous network connection. Only when the new connection and route are established does the mobile node 135 sever its connection with the previous router or agent. This approach significantly decreases hand-off induced packet delays and loss. Moreover, using the information provided by the preferred prediction methods, the mobile node can select from among multiple available network connection nodes to optimize its network connection, thereby optimizing the quality of its network communications. The information provided by the preferred prediction methods is not limited to these examples, moreover, but may be used for other purposes and in other contexts, such as in wireless LANs as well.

In the preferred embodiment in the third generation network example being described, a mobility prediction analysis is periodically carried out with respect to a variable or characteristic related to mobility of the mobile node. The mobility prediction analysis is preferably carried out by the processor facilities of the mobile node 135 according to stored programming provided therein, such processor facilities and stored programming facilities being well-known. Alternatively, however, the mobility prediction can be performed in the processor facilities and stored programming of the mobile node's local BTSS 145 and communicated to the mobile node the same as any other data in the network. In the presently preferred embodiments, the mobility prediction analysis is carried out approximately once per second.

Preferably, the mobility prediction analysis results in the determination of a threshold value, which is selected to indicate when a mobile node has sufficiently moved relative to a fixed BTS or other node that a desired action should be taken by the mobile node. For example, when the predicted value of the variable related to mobility exceeds a selected threshold value, the mobile node may initiate a new network connection and establish a new packet route with a correspondent node before actual hand-off is required. Alternatively or additionally, the mobility prediction analysis may be used to trigger pre-hand-off processing of authentication and security measures, to trigger advance handling of other aspects of the hand-off process itself, or to trigger selection of a new network connection to optimize the quality of the mobile node's connection and/or communications. The specific threshold value selected will depend on the particular action or actions desired to be carried out, particular network characteristics, and various optimization factors.

The mobility prediction analysis is preferably carried out in the network layer 3 logical addressing and routing programming of the mobile node 135 or BTSS 145 with respect to an L3 variable related to mobility. A known conventional method for determining a handoff timing uses beacon strength measured in Layer 2 or the mobility access control (MAC) layer. Under this method, the mobile node 135 constantly monitors and evaluates signal strengths of beacon signals from the current BTS 150 and nearby BTS's 150 and carries out a handoff to a new BTS 150 that is transmitting the strongest beacon signal. Similarly, evaluation of connection to a current BTSS 145 and connectivity to nearby BTSS's 145 is curried out in the network layer 3 through exchanges of packets between the mobile node 135 and the BTSS's 145 as already described above. For instance, routers voluntarily transmit advertisement packets to advertise their presences to mobile nodes passing by. The advertisement packet may be considered a Layer 3 beacon analogous to a Layer 2 beacon for strength measurement. The mobility prediction analysis according to the present invention is curried out in the network layer 3, using these special packets. However, known network layer 2 methods such as beacon strength measurements carried out in the lower level layers may be used to supplement or confirm the layer 3 predictive results. Moreover, the predictive methods of the invention may also be applied to layer 2 variables related to mobility to achieve similar results.

The preferred mobility prediction analysis of the invention is generally sufficient by itself to accurately provide a threshold value to trigger desired actions by the mobile node. Nevertheless, if available, geographic mapping information such as that provided by GPS, may be used if available to supplement or confirm the results of the mobility prediction analysis.

To date, three alternative preferred methods of mobility prediction have been identified: deterministic, stochastic, and adaptive, with adaptive providing superior accuracy results. Generally, the deterministic method is based on the recognition that a functional mapping relationship exists between signal strength S determined in the MAC portion of the physical network layer 2 programming of the mobile node, and packet latency τ identified in the mobile node's network layer 3 programming. It is known that S varies as a function of distance d between the BTS and the mobile node. Thus, the deterministic approach provides a mathematical relationship between latency τ, distance d, and other system parameters such as transmitting power, channel bandwidth, antenna constants, additive white Gaussian noise (AWGN), etc. that can be used to predict future values of packet latency from the values of past samples.

The stochastic method is generally based on the recognition that both L2 signal strength S and L3 packet latency τ are stochastic processes, S(t) and τ(t) respectively, where t is time. Thus, a conventional least mean squares (LMS) approach can be used to predict future L3 packet latency values from the values of past packet latency samples.

The adaptive method also generally employs previously measured values of L3 packet latency τ. This method also employs a conventional least mean squares (LMS) algorithm but with error condition feedback to generate a minimized mean square error (MMSE) prediction of future value of packet latency τ, based on the present value of packet latency τ and a number of previously measured values of packet latency τ.

Preferably, in order to facilitate evaluation and selection of the optimum network connection, the mobile node receives and records sample values for all or at least a significant number of the BTS' from which it receives periodic beacon packets. Typically the period of each beacon signal is on the order of 100 ms and it has been found that 10 samples or less can provide quite accurate mobility prediction results. Preferably, the mobile node carries out mobility prediction for each BTS for which it is receiving and storing samples.

To begin with, relationship between the layer 2 variables and the layer 3 variables is analyzed. The purpose of this analysis is to, focusing on signal strengths measured in Layer 2 and values of packet latency measured in Layer 3, formulates a mathematical equation for mapping these variables from one layer to the other. Now, let S(t₀), S(t₁), . . . , S(tₙ) be n+1 consecutive samples of beacon strengths measured in Layer 2 at times t₀, t₁, . . . , tₙ. Also, let τ(t₀), τ(t₁), . . . , τ(tₙ) be n+1 consecutive samples of packet latency values measured in Layer 3 at times t₀, t₁, . . . , tₙ. Packet latency τ represents latency of a beacon packet transmitted from a nearby router or BTS to the mobile node. Packet latency τ may be regarded as an L3 indicia indicating the quality of wireless connectivity between the BTS and the mobile node.

Both theoretical and experimental analyses have confirmed that a functional mapping exists between packet latency τ and signal strength S, which may be expressed by equation τ=f(S). Using this relation, it is thus possible to construct a probabilistic model for packet latency τ based on a known probabilistic model for signal strength S. If Pₑ represents the probability of packet error, i.e., the rate at which packets are corrupted and must be retransmitted, which can be estimated from the bit error rate, then:

$$E = \frac{1}{1 - {P}_{e}} \qquad ( 1 )$$

where, E is the expected number of transmission attempts required to successfully send a packet from a transmitter, e.g., BTS, to a receiver, e.g., the mobile node. Then, packet latency τ can be expressed as:

$$τ ≅ \frac{{T}_{x}}{1 - {P}_{e}} + {T}_{proc} \qquad ( 2 )$$

where, Tₓ is the total transmission time per packet determined as propagation delay+packet size/bit rate, and T_{proc} denotes miscellaneous processing time. In additive white Gaussian noise (AWGN), the probability of a bit or symbol error occurring becomes a function of the received signal to noise ratio (SNR). Thus, statistical relation between the probability of a bit or symbol error and SNR can be expressed with Gaussian Q-function by applying wireless communication theories. In fact, it is true that the probability of a bit or symbol error occurring is approximately inversely proportional to the received SNR. Thus, the probability of packet error is also inversely proportional to the received SNR. I.e.,

$${P}_{e} ∝ \frac{1}{γ} ⇔ {P}_{e} = \frac{J}{γ} = \frac{J}{\frac{S}{{BN}_{0}}} = \frac{{JBN}_{0}}{S} \qquad ( 3 )$$

where, γ is SNR, J is a constant, S is the received signal power, B is the receiver bandwidth, and N₀ is noise power spectral density. Combining Equations (2) and (3) (and ignoring T_{proc} which should be relatively constant from packet to packet), S and τ are then mathematically related as follows:

$$τ \approx \frac{{ST}_{x}}{S - {JBN}_{0}} \qquad ( 4 )$$

or, in terms of SNR:

$$τ \approx \frac{γ {T}_{x}}{γ - J} \qquad ( 5 )$$

Turning once again to the preferred deterministic approach and referring to FIG. 3, the mobile node 135 periodically receives beacon signals from one or more BTS' 150. The format and content of the beacon signals and their processing in the physical network L3 layer programming of the mobile node are standard and detailed description is omitted here. Typically, the beacon signals will have a period of approximately 100 ms. It is known that the strength or magnitude of the beacon signals S vary with the distance d between the BTS and the mobile node and it is assumed that the distance d between the BTS and the mobile node is varying with respect to time t. Included in the network level L3 programming of the mobile node is programming 200 to receive and store a number of samples of BTS to mobile node distance, to execute a mathematical algorithm to derive from the distance samples and to store a corresponding number of samples of L3 packet latency τ, and to predict a future value for packet latency τ with respect to the BTS from the sample set.

Unfortunately, however, it is also known that the strength S of the beacon signals is affected not only by the distance d between the BTS and the mobile node but also by other factors such as intervening structures, interference by other BTS', etc. Therefore, the deterministic prediction method of the present invention will be discussed here separately for wireless communications in a free space environment (no fast fading) and in a multi-path fading environment.

First, in a free space path loss model, the received signal strength S is inversely proportional to the square of the distance d between the transmitter and receiver. A simplified path loss model is given by the equation:

$$S = \frac{{KP}_{i}}{{f}^{2} {d}^{i}} ( 2 \leq i \leq 4 , for free space i = 2 ) \qquad ( 6 )$$

K is the free space constant, Pₜ is transmitted power, f is frequency, d is the distance separating the transmitter and receiver, and i is a coefficient such that 2 is less than or equal to i which is less than or equal to 4, with a being equal to 2 in free space.

By substituting Equation 6 for S in Equation 4, we then derive a model for L3 packet latency τ as follows:

$$τ ≅ \frac{{T}_{x}}{1 - \frac{{Jd}^{i} {N}_{0} B}{{KP}_{i}}} \qquad ( 7 )$$

By letting β equal J/K, Equation (7) becomes as follows:

$$τ ≅ \frac{{T}_{x} {P}_{t}}{{P}_{i} - β {d}^{i} {N}_{0} B} \qquad ( 8 )$$

Equation (8) estimates packet latency τ in a free space path loss environment, given Tₓ, β, Pₜ, d, B and N₀. Except d, which is the distance between the BTS and the mobile node, all of the parameters of Equation (8) are system parameters obtainable from either layer 2 or layer 3 programming of the mobile node. Thus, in the deterministic method, d is determined by measurement and is then applied to Equation (8) to solve for τ. There are a number of potential ways to measure d. If a number of BTS cells are present such that the mobile node is receiving beacon signals from at least three BTS', conventional triangulation techniques based on relative beacon signal strength measurements can be used to determine the mobile node's distance from each BTS. Another way is to use GPS.

By solving Equation 8 periodically and repeatedly a consecutive series of values of τ is derived. Standard regression analysis is then performed to statistically fit the samples into regression curves. The regression curves are then extrapolated to predict one or more values of τ at a selected point or points in the future. The regression analysis may comprise a relatively simple linear regression, which is easily performed but which may result in less accurate prediction results, or a more complex and computationally demanding regression if better prediction accuracy is required. By periodically updating the sample base, i.e., d measurements and estimated corresponding τ values, and re-performing the regression analysis, future values of τ can be readily predicted for the mobile node relative to its BTS as the mobile node moves within the network relative to its BTS. It is envisioned that the typical time period for which τ will be predicted will be approximately 1 second, which roughly corresponds to a ten 100 ms beacon signal periods. However, longer or shorter prediction time frames may be used if desired, with the recognition that the longer the time frame, the less accurate the prediction is likely to be.

Unlike the free space path model, the multiple fading model more realistically reflects actual environments through which signals propagates. The multiple fading environment may be accurately represented by a model with the Rayleigh fading. Without diversity combining methods at a receiver antenna, a signal is severely degraded due to the multipath fading. In CDMA systems, RAKE receiver is designated to gain path diversity via path combining methods. Maximal Ratio Combining (MRC) is the basis for gaining path diversity for RAKE receivers. According to Equation (3),

$${P}_{e} = \frac{J}{γ} \qquad ( 3 )$$

In the multiple fading environment, γ, or the received SNR, is a random variable. Each branch in MRC with multipath diversity has an average SNR, or Γ, i.e.,

$$Γ = \frac{S}{{N}_{0} B} {\overline{α}}^{2} \qquad ( 9 )$$

where, \overline{α²} is the squared average of a gain of the Rayleigh fading channel. α has Rayleigh distribution and α² has an exponential distribution. Then, the average SNR, or \overline{γ_{M}}, of the multi-branch MRC is:

$${\overline{γ}}_{M} = {\sum }_{i = 1}^{M} {\overline{γ}}_{i} = {\sum }_{i = 1}^{M} Γ = M Γ \qquad ( 10 )$$

Accordingly, packet latency τ estimated for a RAKE receiver in the Rayleigh fading environment can be obtained by:

$$\overline{τ} = \frac{{T}_{x} {\overline{γ}}_{M}}{{\overline{γ}}_{M} - J} \qquad ( 11 )$$

where, \overline{τ} is a predicted value of packet latency on average. Using Equations (9) and (11), Equation (8) for the free space no fading environment becomes:

$$\overline{τ} = \frac{{MT}_{x} {P}_{i} {\overline{α}}^{2}}{{MP}_{i} {\overline{α}}^{2} - β {d}^{i} {N}_{0} B} \qquad ( 12 )$$

The preferred stochastic method is based on the same relationships and models expressed in Equations (1)-(8), and the further recognition that τ(t) is itself a stochastic process. The least mean square (LMS) theory is a well-recognized theory for finding an expected future value based on of past stochastic values. Using the LMS, an estimated future value of packet latency τ is expressed as follows:

$${\hat{τ}}_{{l}_{v + 1}} = E [ τ ( {t}_{N + 1} ) \vert τ ( {t}_{N} ) , τ ( {t}_{N - 1} ) , … , τ ( {t}_{0} ) ] \qquad ( 13 )$$

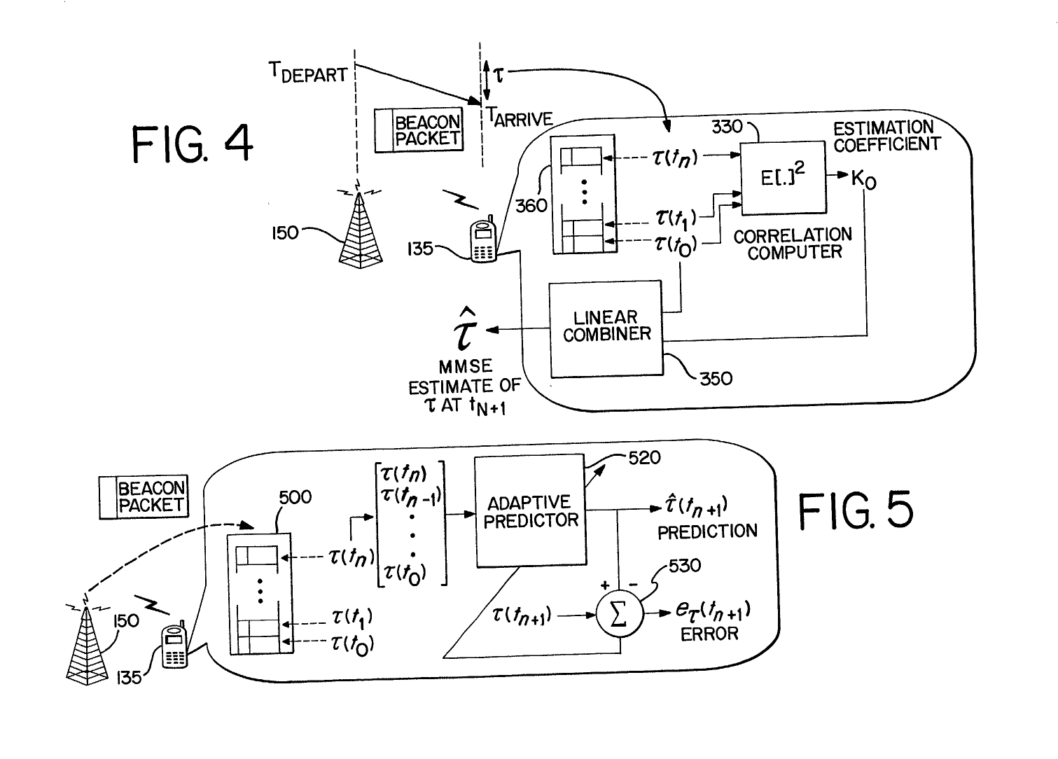

As illustrated in FIG. 4, in the stochastic method the mobile node 135 obtains a sample set of latency values τ over a sample time period by measuring the latency time of beacon packets arriving from the BTS 150. This may be accomplished, for example, by time stamping and sending beacon packets from the BTS to the mobile node and measuring, at the mobile node, the total packet latency as the difference between the arrival time at the mobile node and the time stamped. Sample latency values τ may be obtained by carefully synchronizing the BTS and the mobile node. The mobile node 135 thus determines a set of sample latency values τ (t₀-tₙ) and stores them in a memory 300. The set of latency values τ are input to a correlation computer 330, which provides estimation coefficients K₀ using a conventional linear least mean square (LMS) technique. The estimation coefficients K₀ are input to a conventional linear combiner 350 which applies them to the sample latency values τ to generate a predicted latency value τ relative to the BTS at a future time index tₙ₊₁ by a conventional minimization of mean square error (MMSE) technique. The predicted future latency value τ may then be compared to a predetermined threshold value to trigger a desired action or used to optimize the mobile node's network connection as previously described. The same considerations relating to the measurement of distance and selection of the time index for predictions of latency τ expressed with respect to the deterministic method also apply to the stochastic method.

Again, the stochastic method is based on the premise that τ(tₙ₊₁) can be predicted by applying a conventional least mean squares (LMS) to the sample latency values τ at previous time indices. The solution of Equation (13) is given by the following expression:

\hat{τ}ₜ_{ₙ₊₁}=K₀τₜ_{ₙ} (14)

where,

$$\underline{{τ}_{{t}_{n}}} = [ \begin{matrix} τ ( {t}_{n} ) \\ τ ( {t}_{n - 1} ) \\ ⋮ \\ τ ( {t}_{0} )\end{matrix} ]$$

and K₀[kₙ kₙ₋₁ . . . k₀]

A unique solution exists to minimize the mean square error expressed by Equations (13) and (14), which is:

K₀ R_{90 =R}_{90 π}_{₁}_{ₙ}

K₀=R_{ππ}_{_{π}}_{ₙ}R₉₀⁻¹ (15)

where, R_{τ} is an autocorrelation matrix, i.e., R_{τ}=Eττ*, and R_{τ}_{τ}_{ₜₙ} is a crosscorrelation matrix, i.e., R_{τ}_{τ}_{ₜₙ}=Eττ*ₜₙ.

The computational complexity of the prediction can be reduced if it is assumed that the distance d(t) between the BTS and mobile node over time is a Markovian process. That is, it is assumed that the values of d(t) measured at discrete intervals of time approximately form a Markov chain. If d(t) forms a Markov chain, latency values τ(t) also form a Markov chain because τ(t) is deterministic based on d(t) as shown by Equations (8) and (12). It is recognized that in a Markovian chain, the conditional distribution of future values of a state Xₙ₊₁ given the values of past states X₀, X₁, . . . , Xₙ₋₁, and of present state Xₙ, is independent of the past states and depends only on the value of the current state, as shown in the following expression:

Pr{Xₙ₊₁|Xₙ,Xₙ₋₁, . . . ,X₀}=Pr{Xₙ|Xₙ₋₁} (16)

Equation 13 shows that a future latency value τ(tₙ₊₁) can be predicted based on the present and past latency values τ(tₙ), τ(tₙ₋₁), . . . , τ(t₀). Although the preferred stochastic mobility model is not strictly Markovian, it has been found that past latency values τ are considerably more uncorrelated with future latency values τ than is the present latency value τ. Taking this into account, a future latency value τ(tₙ₊₁) may be predicted based on the present and several past latency values τ(tₙ), τ(tₙ₋₁) and τ(tₙ₋₂). Thus, Equation 13 may alternatively be expressed as follows:

τ_{predicted}(tₙ₊₁)≈E[τ(tₙ₊₁)|τ(tₙ),τ(tₙ₋₁),τ(tₙ₋₂)] (17)

Given this prediction model, future latency values τ can be sufficiently accurately predicted using the following algorithms:

\hat{τ}ₜ_{_{N+1}}=K₀τₜ_{_{N}} (18)

where,

$${\hat{τ}}_{{t}_{N + 1}} = {K}_{0} \underline{{τ}_{{i}_{N}}} where , \\ \underline{{τ}_{{i}_{N}}} = [ \begin{matrix} τ ( {t}_{n} ) \\ τ ( {t}_{n - 1} ) \\ τ ( {t}_{n - 2} )\end{matrix} ] and {K}_{0} = [ {k}_{n} {k}_{n - 1} {k}_{n - 2} ] . \qquad ( 18 )$$

and K₀=[kₙ kₙ₋₁ kₙ₋₂].

Finally, the preferred adaptive prediction method is illustrated graphically in FIG. 5. Like the deterministic and stochastic methods, the adaptive method is preferably carried out in the mobile node's L3 network level programming. Like the stochastic method, the adaptive prediction method predicts mobility based solely on L3 packet latency samples. Advantageously, the adaptive prediction method does not require measurements of signal strength or distance based on lower L2 level processes, and does not depend upon any system parameters. The mobile node periodically determines a consecutive set of packet latency samples τ(t₀) to τ(tₙ) over a sample time period, preferably about one second. In the preferred embodiment, the use of ten samples derived from ten 100 ms period BTS beacon signals has been found sufficient. The sample latency values τ are suitably obtained in the same fashion previously described with respect to the preferred stochastic method. The samples are preferably stored in a memory 500. As each new sample is determined it replaces the oldest sample in the memory 500. The samples are input seriatim from memory to an adaptive predictor 520. The adaptive predictor 520 generates a predicted future value τ(tₙ₊₁) from the samples τ(t₀) to τ(tₙ) using a conventional least mean square (LMS) technique to iteratively calculate weight coefficients for the samples. The predicted value of τ(tₙ₊₁) is input to a summer 530, where it is summed with the value of the subsequently determined actual τ(tₙ₊₁) sample to generate an error signal e_{τ}(tₙ₊₁). The error signal is fed back to the adaptive predictor and used to adjust the weight coefficients accordingly.

The following three models are available for the adaptive prediction method:

\hat{τ}_{Adaptive}=ω₀τ_{D}(dₑₛₜ+Δd)+ω₁τ(tₙ)+ω₂τ(tₙ₋₁) (19)

where, τ_{D}=ƒ(d), dₑₛₜ=ƒ⁻¹(τ), Δd=dₜₙ−dₜₙ₋₁ and ω₀, ω₁ and ω₂ are weight coefficients.

\hat{τ}_{Adaptive}=ω₀τ(tₙ)+ω₁τ(tₙ₋₁)+ω₂τ(tₙ₋₂) (20)

\hat{τ}_{Adaptive}=τ(tₙ)+ω₀Δ₀+ω₁Δ₁ (21)

where, Δ₀=tₙ−tₙ₋₁ and Δ₁=tₙ₋₁−tₙ₋₂.

Equation (19) requires the most complex computation of all. As shown by Equations (8) and (12), a deterministic relation exists between the packet latency τ and the distance d between the BTS and the mobile node, which is summarily expressed as τ_{D}=ƒ(d). Thus, τ_{D}(dₑₛₜ+Δd) can be obtained from either Equation (8) or (12) by solving the Equation backwards. Equation (20) is simpler than Equation (19) and uses the present and two previous packet latency samples. Equation (21) is further simpler.

The weight coefficients ω₀, ω₁ and ω₂ can be obtained by a minimization of mean square error (MMSE) technique. Thus, a set of weight coefficients ω₀, ω₁ and ω₂ is a function of time and determined based on a set of past weight coefficients and an error feedback, which is a difference between a predicted latency and the actual measured latency. The optimal weight coefficients ω₀, ω₁ and ω₂ for, for instance, Equation (19) are expressed by the following algorithm:

$${[ \begin{matrix}{ω}_{0} \\ {ω}_{1} \\ {ω}_{2}\end{matrix} ]}_{{t}_{n + 1}} = {[ \begin{matrix}{ω}_{0} \\ {ω}_{1} \\ {ω}_{2}\end{matrix} ]}_{{t}_{n}} + 2 {μϵ}_{{t}_{n}} [ \begin{matrix} {τ}_{D} ( {d}_{est} + Δ d ) \\ τ ( {t}_{n} ) \\ τ ( {t}_{n - 1} )\end{matrix} ] \qquad ( 22 )$$

where,

$${ϵ}_{{t}_{n}} = τ ( {t}_{n} ) - {{[ \begin{matrix} {τ}_{D} ( {d}_{est} + Δ d ) \\ τ ( {t}_{n - 1} ) \\ τ ( {t}_{n - 2} )\end{matrix} ]}^{T} [ \begin{matrix}{ω}_{0} \\ {ω}_{1} \\ {ω}_{2}\end{matrix} ]}_{{t}_{n - 1}}$$

and μ is a gain constant that regulates the speed and stability of adaptation of Equation (22). Large μ makes the adaptation faster because the weight coefficients are adjusted greater at each iteration. Empirically, μ=0.05 has been determined to be the optimum value for μ.

As with the predicted future values τ generated by the deterministic and stochastic methods, the predicted future value τ generated by the adaptive prediction method can be compared to a predetermined threshold value in order to trigger a desired action by the mobile node, such as initiating a new network connection and pre-establishing a new packet route before hand-off, or pre-initiating required authentication and security processes before hand-off. Provided it is calculated for a plurality of BTS' from which the mobile node is receiving beacon packets, it can also be used by the mobile node to optimize its network connection by switching connections to the BTS with the lowest predicted value τ for the next sample period.

Those skilled in the art will also realize that while the preferred mobility prediction methods have been described with respect to L3 network layer packet latency as the subject variable to be predicted, they are equally applicable and able to predict L2 network link layer variables related to mobility, such as signal to interference ratio (SIR), signal to noise ratio (SNR), and pilot signal strength, if desired or needed.

What has been described are preferred embodiments of the present invention. The foregoing description is intended to be exemplary and not limiting in nature. Persons skilled in the art will appreciate that various modifications and additions may be made while retaining the novel and advantageous characteristics of the invention and without departing from its spirit. Accordingly, the scope of the invention is defined solely by the appended claims as properly interpreted.

What is claimed is:

1. A method for predicting mobility of a mobile node relative to one or more fixed nodes in a wireless, mobile access, digital network, comprising:
obtaining a plurality of samples of a first physical parameter the value of which is related to the mobility of said mobile node; and
statistically processing said plurality of samples and generating a predicted future value of said parameter.

2. The method of claim 1 wherein said first physical parameter is packet latency.

3. The method of claim 1 wherein the step of obtaining a plurality of samples comprises deterministically obtaining said samples from samples of a second related physical parameter.

4. The method of claim 3 wherein said first physical parameter is packet latency and wherein said second physical parameter is transmitter to receiver distance.

5. The method of claim 1 wherein the step of obtaining a plurality of samples comprises measuring said samples.

6. The method of claim 6 wherein said first physical parameter is packet latency.

7. The method of claim 6 wherein said packet latency is measured by:
time stamping a packet;
transmitting the packet from said mobile node to a said fixed node;
retransmitting said packet from said fixed node to said mobile node;
noting the time of arrival of said packet at said mobile node;
calculating one way latency of the packet from said fixed node to said mobile node from the value of said time stamp and the value of said arrival time.

8. The method of claim 1 wherein the step of statistically processing comprises application of a least mean squares algorithm.

9. The method of claim 8 wherein the step of statistically processing comprises application of an algorithm to minimize mean square error.

10. The method of claim 1 wherein said first physical parameter is a stochastic process.

11. The method of claim 10 wherein the step of statistically processing comprises a stochastic prediction process.

12. The method of claim 11 wherein said stochastic prediction process comprises:
inputting said sample values of said first physical parameter to a correlation computer and generating an estimation coefficient;
inputting said estimation coefficient and said sample values to a linear combiner and generating a minimized mean square error predicted value of said first physical parameter at a future time.

13. The method of claim 1 wherein the step of statistically processing comprises an adaptive prediction process.

14. The method of claim 13 wherein said adaptive prediction process comprises:
inputting said sample values of said first physical parameter to an adaptive predictor and generating a predicted value of said first physical parameter at a selected time in the future;
obtaining the actual value of said first physical parameter at said selected time;
comparing said predicted value and said actual value and generating an error value;
feeding back said error value to said adaptive predictor and adjusting the predicted value of said first physical parameter at a next selected time in the future.

15. The method of claim 14 wherein said sample values are iteratively input to said adaptive predictor and wherein said adaptive predictor iteratively predicts values of said first physical parameter at successive selected times in the future.

16. The method of claim 13 wherein said adaptive predictor comprises a least mean square algorithm and an algorithm for minimizing mean square error.

17. The method of claim 1, including:
comparing said predicted future value with a predetermined threshold value; and
initiating a desired action when said predicted future value meets or exceeds said threshold value.

18. The method of claim 1 wherein said first physical parameter is selected from the group comprising: signal to interference ratio, signal to noise ration, pilot signal strength.

19. The method of claim 1 wherein:
said first physical parameter is packet latency;
a future value of packet latency is predicted with respect to each of a plurality of fixed nodes in the network; and
a network connection is established between said mobile node and said fixed node exhibiting the lowest predicted value of packet latency.
